(19) United States
(12) Patent Application Publication
(10) Pub. No.: US 2016/0145457 A1
(43) Pub. Date: May 26, 2016

(54) COATINGS FOR THE BACKSIDES OF WOODEN BOARDS

(71) Applicant: VALSPAR SOURCING, INC., Minneapolis, MN (US)

(72) Inventors: John F. Grunewalder, Ocean Isle Beach, NC (US); Herbert D. Temple, Archdale, NC (US); James V. Mirante, Archdale, NC (US)

(21) Appl. No.: 14/904,380

(22) PCT Filed: Jul. 11, 2014
(86) PCT No.: PCT/US14/46372

§ 371 Date: Jan. 11, 2016

Related U.S. Application Data
(60) Provisional application No. 61/845,458, filed on Jul. 12, 2013.

(51) Int. Cl. C09D 127/08; C09D 7/12; C09D 5/00; C09D 163/10; C09D 175/16

(52) U.S. Cl. CPC C09D 127/08; C09D 163/10; C09D 175/16; C09D 5/002; C09D 7/1216; C08K 3/36

(57) ABSTRACT

A method includes applying a hydrophobic coating composition to a backside of a wooden board to prevent warping and cupping when the board is exposed to water vapor. The coating composition can include a chlorinated resin and water, or may be a solvent-based or a 100% solids composition including an epoxy(meth)acrylate, a polyester(meth)acrylate, a polyether(meth)acrylate, or a polyurethane(meth)acrylate, a multifunctional (meth)acrylate, and a photoinitiator.

### BACKGROUND

Wooden boards used as hardwood flooring materials can warp and cup when exposed to humidity, particularly when the boards are more than about three and a quarter inches (about 8.25 cm) wide. In most flooring boards the top surface is covered by a coating, but the underside remains uncoated. When exposed to humidity, the underside of the board can absorb moisture vapor, and the resulting differential expansion and contraction between portions of the board can cause warping and cupping to occur. For example, this warping and cupping can occur when the wooden flooring boards are installed in a humid environment over an unheated crawl space. Flooring manufacturers have tried various techniques to minimize the tendency to warp and cup. In some cases, grooves of varying width and depth are cut in the underside of the boards, but these grooves have not in all cases eliminated the problem, particularly for wider boards.

### SUMMARY

In general, the disclosure relates to coatings that, when applied to an underside of a wooden board, significantly reduce and/or eliminate the tendency of the wooden board to absorb moisture vapor. This reduction in moisture ingress reduces the tendency of the wooden board to warp and cup when exposed to humid environments.

In one embodiment, the present disclosure is directed to a method including applying an aqueous coating composition to a backside of a wooden substrate, wherein the aqueous coating composition includes a polyvinylidene chloride copolymer and water.

In another embodiment, the present disclosure is directed a method including applying an aqueous coating composition to a backside of a wooden board, wherein the aqueous coating composition includes 70 wt % to 98 wt % of a polyvinylidene chloride resin and about 2 wt % to about 30 wt % water.

In another embodiment, the present disclosure is directed to a method including applying to a backside of a wood board a coating composition including an epoxy, polyester, polyether, and polyurethane(meth)acrylate, a multifunctional (meth)acrylate, a photoinitiator, and an organic solvent.

In yet another embodiment, the present disclosure is directed to a method including applying to a backside of a wood board an ultraviolet (UV) curable coating composition including about 10 wt % to about 70 wt % of an urethane (meth)acrylate, about 1 wt % to about 50 wt % of a difunctional (meth)acrylate, about 0.1 wt % to 15wt % of at least one photoinitiator, and about 3 wt % to about 50 wt % of at least one organic solvent. In yet another embodiment, the present disclosure is directed to a method including applying to a backside of a wood board a radiation curable coating composition comprising at least one of an epoxy, polyester, polyether, and polyurethane(meth)acrylate, at least one multifunctional (meth)acrylate monomer, a photoinitiator, and less than about 5 wt % of an organic solvent.

In another embodiment, the present disclosure is directed to a method including applying to a backside of a wood board a UV curable coating composition including about 5 wt % to about 50 wt % of at least one of an epoxy, polyester, polyether, and polyurethane(meth)acrylate, about 5 wt % to about 75 wt % of at least one (meth)acrylate monomer, about 0.1 wt % to about 15wt % of a photoinitiator, and less than about 5 wt % of an organic solvent.

In another embodiment, the present disclosure is directed to a method including applying to a backside of a wood board a UV curable coating composition including about 5 wt % to about 50 wt % of at least one of an epoxy, polyester, polyether, and polyurethane(meth)acrylate, about 5 wt % to about 75 wt % of at least one (meth)acrylate monomer, about 0.1 wt % to about 15 wt % of a photoinitiator, wherein the UV curable coating composition is substantially free of organic solvent.

The details of one or more embodiments of the invention are set forth in the description below. Other features, objects, and advantages of the invention will be apparent from the description, and from the claims.

### DETAILED DESCRIPTION

The term wood in this application refers to any material of cellulose/lignin derived from the hard, fibrous structural tissue in the stems and roots of trees or other woody plants. Wood includes, for example, hardwood and softwood lumber directly cut from trees, as well as engineered wood composites made from strands, particles, fibers or veneers of wood. Examples of wood composites include, but are not limited to, plywood, oriented strand board (OSB), medium-density fiberboard (MDF), particle boards, and the like. Exemplary woods include hardwood species such as ash, alder, birch, cherry, mahogany, maple, oak, poplar, teak, hickory and walnut, and softwood species such as cedar, fir, pine and redwood. Finished wood products coated with such compositions can have a wide variety of end uses including furniture, kitchen cabinetry, flooring (including engineered flooring), and doors and trim. The wood can be cut or formed into a wide variety of shapes for use as a structural or a building material.

A typical wooden board includes a top side, an underside or backside opposite the top side, and edges between the top side and the backside. If the board is to be used for wooden flooring or trim, the underside may have an arrangement of generally longitudinal grooves.

The top side or face of the board, which is exposed and viewable as the board is being used for its intended application, can have applied thereon a wide variety of crosslinked and un-crosslinked polymeric coatings. These coatings include, but are not limited to, polyether, polyurethane, epoxy, polyamide, melamine, acrylate, polyolefin, polystyrene, and fluorinated polymer resins, as well as copolymers and blends of these polymer and copolymer resins. These resins may be formulated into water-borne, water-soluble, emulsion, or solvent-borne coatings, as well as solvent-free 100% solids coatings.

The underside and edges of the wooden board, which in most applications are hidden from view during use, have heretofore in many cases remained uncoated. The present disclosure relates to hydrophobic coatings that, when applied to the underside and/or edges of a wooden board, significantly reduce and/or eliminate the tendency of the wood or wood product to absorb moisture vapor. This reduction in moisture ingress reduces the tendency of the wood to warp and cup when exposed to humidity.

The hydrophobic coatings in this disclosure may be formulated in a wide variety of ways, including water-borne, water-soluble, emulsion, or solvent-borne coatings, as well as substantially solvent-free 100% solids coatings.

In one embodiment, the hydrophobic wood coating is formulated as an aqueous coating composition including a film-forming resin component admixed with in an aqueous carrier. The aqueous coating composition may be a single phase solution in which one or more components including at least the film-forming resin component are substantially fully dispersed in the aqueous carrier. Alternatively, the coating compositions may include two or more phases. Compositions including two or more phases may be dispersions in which one or more phases are dispersed in a continuous phase of another material and/or phase. In some embodiments, dispersions are suspensions including, but not limited to, colloidal suspensions. In some embodiments, coating compositions are a latex or emulsion including polymer microparticles dispersed in an aqueous carrier.

The film-forming resin in the aqueous coating composition includes at least one chlorinated resin. Chlorinated resins have excellent barrier properties, and endow coatings with excellent moisture vapor resistance. A particularly preferred chlorinated resin is polyvinylidene chloride copolymer (PVDC).

A wide range of suitable embodiments of polyvinylidene chloride resins are available from commercial sources. Examples of commercially available embodiments include, but are not limited to, those available under the trade designations DIOFAN (available from Solvay Plastics), SURFENE from Dow Chemical, Midland, Mich., POLIDENE (e.g., 33-082, 33-038, 33-086, 33-083, 33-075, and 33-081 available from Scott Bader), HALOFLEX (e.g., 202 and 202S available from DSM Neoresins), PERMAX (e.g., 803 and 805 available from Lubrizol), and the like

The amount of the film forming resin component in the aqueous coating composition may be selected from a wide range. Generally, if the amount of the film forming resin component is too low, then it may be difficult to form a film, more difficult to form a film that has sufficient adhesion to the wood substrate, or the film may have insufficient moisture resistance. The aqueous coating composition preferably includes from about 10 to 99 wt %, more preferably about 50 to 98 wt %, and most preferably about 70 to 98 wt % of the resin component, based on the total weight of the aqueous coating composition.

Other optional components for use in the aqueous coating composition are described in Koleske et al., Paint and Coatings Industry, April, 2003, pages 12-86. Typical performance enhancing additives that may be employed include surface active agents, pigments, colorants, dyes, surfactants, dispersants, defoamers, thickeners, heat stabilizers, leveling agents, coalescents, biocides, mildewcides, anti-cratering agents, curing indicators, plasticizers, fillers, sedimentation inhibitors, ultraviolet light absorbers, optical brighteners, and the like to modify properties. In some embodiments, the performance-enhancing additives are present at about less than 5 wt % of the total composition, or less than 1 wt % of the total aqueous coating composition.

In the aqueous coating composition, the film-forming resin component is in admixture with about 40 wt % to about 60 wt % of an aqueous liquid carrier, based on the total weight of the composition. As used herein, “aqueous” means that at least about 5 weight percent, preferably at least about 20 weight percent, more preferably at least about 40 weight percent, and even more preferably at least about 60 weight percent, and even 90 weight percent or more of the liquid carrier is water, based upon the total weight of the liquid carrier. Most preferably, from about 85 to 100 weight percent, more preferably about 85 to 95 weight percent of the liquid carrier is water. Suitable optional co-carriers may be incorporated into the aqueous coating composition for a variety of purposes, including helping in film formation and/or paint stability. Examples of suitable co-carriers include organic solvents such as alcohols, ketones, glycol ethers, and the like.

The aqueous coating composition may be applied to the backside or edges of a wood board as a stand-alone coating, or may be used as a primer/sealer coating beneath one of the UV curable coatings described herein.

In another embodiment, the hydrophobic wood coating is formulated as a radiation curable, solvent-borne composition including a hydrophobic oligomer or resin, a multifunctional (meth)acrylate monomer, a photoinitiator, a solvent, and selected additives.

The hydrophobic oligomers, resins or combinations thereof suitable for use in the radiation curable, solvent-borne composition are mono or poly-esters of (meth)acrylic acid. Suitable examples include, but are not limited to, epoxy, polyester, polyether, and polyurethane(meth)acrylates. One particularly useful resin is an urethane(meth)acrylate, which is some embodiments can be multifunctional. These hydrophobic oligomers can be obtained by reacting isocyanate groups of a polyisocyanate, such as hexamethylene diisocyanate with a hydroxyalkyl(meth)acrylate, e.g. hydroxyethyl(meth)acrylate. In some embodiments, these urethane(meth)acrylates may be further polymerized with an additional monomer such as polybutadiene to provide an oligomer with enhanced moisture repellant properties and good flexibility. Suitable examples include, but are not limited to, the polybutadiene urethane(meth)acrylates available from Dymax, Torrington, Conn., under the trade designation BOMAR 641S and BOMAR 643.

The hydrophobic oligomer may be present in the radiation curable solvent borne coating composition at about 10 wt % to about 70 wt %, at about 30 wt % to about 60 wt %, or at about 40 wt % to about 50 wt %, based on the total weight of the composition.

The radiation curable solvent-borne coating composition also includes a hydrophobic multifunctional (meth)acrylate monomer. The (meth)acrylate monomer may vary widely depending on the intended application, and examples include, but are not limited to, difunctional monomers such as 1,-6-hexanediol diacrylate, dipropylene glycol diacrylate, and tricyclodecane dimethanol diacrylate, as well as trifunctional monomers such as trimethylolpropane triacrylate and pentaerythritol triacrylate. Higher functional acrylic monomers like pentaerythritol tetraacrylate, dipentaerythritol penta-acrylate may also be used, as well as polyacrylates of higher polyols having six or more hydroxyl groups. Suitable multifunctional acrylates are available from, for example, Sartomer Corp., Exton, Pa.

The multifunctional (meth)acrylate monomer or oligomer may be present in the solvent borne coating composition at about 1 wt % to about 50 wt %, at about 3 wt % to about 30 wt %, or at about 5 wt % to about 20 wt %, based on the total weight of the composition.

An optional ethylenically unsaturated resin may be included in the radiation curable solvent borne coating composition. The ethylenically unsaturated resin may be incorporated to facilitate blending of the components of the coating composition, to increase the solids content without increasing the coating viscosity or volatile organic compound (VOC) content, or to enhance (in some cases, synergistically) various coating performance characteristics such as adhesion, hardness, flexibility, hydrophobicity, and chemical resistance. Suitable ethylenically unsaturated resins include polyesters, acrylics, epoxy, polyethers, and a variety of low molecular weight functional resins.

The optional ethylenically unsaturated resins may, for example, represent less than about 20 wt %, between about 1 wt % and about 15 wt %, between about 1 wt % and about 10 wt %, or between about 1 wt % and about 5 wt %, based on the total weight of the coating composition.

The radiation curable solvent-borne coating compositions of this disclosure may also optionally include one or more flow control agents. Flow control agents may facilitate coating the composition onto a substrate. Exemplary flow control agents include silicones, fluorocarbons, acrylic resins, and the like. A flow control agent may, for example, represent between about 0.1 wt % and about 3 wt %, between about 0.4 wt % and about 2 wt %, or between about 0.5 wt % and 1.5 wt %, based on the total weight of the coating composition.

The radiation curable solvent borne coating compositions are curable by radiation, e.g., visible light, ultra violet (UV) light, and the like. A wide variety of photoinitiators can be used in the composition, including, but not limited to, alpha-hydroxyketones, phenylglyoxalates, benzyldimethyl ketals, α-aminoketones, mono acyl phosphine oxides (MAPO), bis acyl phosphine oxides (BAPO), phosphine oxides. Specific photoinitators include, but are not limited to, benzophenone, 1-hydroxy-cyclohexylphenyl-ketone (such as those available under the trade designation IRGACURE 184), methylbenzoylformate (such as those available under the trade designation DAROCUR MBF), alpha, alpha-diethoxy-alpha phenylacetophenone, 1-hydroxycyclohexyl benzophenone, phenyl bis(2,4,6-trimethyl benzoyl)phosphine oxide sold under the trade designation IRGACURE 819 and diphenyl(2,4,6-trimethylbenozyl)phosphine oxide. The photoinitiators may be used singly or in combination. Products identified with the IRGACURE and DAROCUR trade designations are available from BASF AG, Florham Park, N.J.

In some embodiments of the radiation curable solvent borne coating composition, the photoinitiator is present at about 0.2 wt % to about 15 wt % of the non-volatile components, or at about 0.5 wt % to about 10 wt %, or about 0.75 wt % to about 5 wt % of the non-volatile components of the coating composition.

Other optional components for use in radiation curable solvent borne coating composition are described in Koleske et al., Paint and Coatings Industry, April, 2003, pages 12-86. Typical performance enhancing additives that may be employed include surface active agents, pigments, colorants, dyes, surfactants, dispersants, defoamers, thickeners, heat stabilizers, leveling agents, coalescents, biocides, mildewcides, anti-cratering agents, curing indicators, plasticizers, fillers, sedimentation inhibitors, ultraviolet light absorbers, optical brighteners, and the like to modify properties. In some embodiments, the performance-enhancing additives are present at about less than 5 wt % of the total composition, or less than 1 wt % of the total composition.

The radiation curable solvent-borne coating composition further includes about 3 wt % to about 50 wt % of at least one organic solvent, and in some embodiments about 25 wt % to about 35 wt % of a solvent or a combination of solvents. The solvent may vary widely depending on the intended application, and suitable examples include aromatics, ketones, ethers, esters, and alcohols. Suitable solvents include, but are not limited to, toluene, acetone, and the like.

The radiation curable solvent borne coating composition may be applied to the backside or edges of a wood board as a stand-alone sealer or primer coating, or may be used as a top coat over the aqueous primer/sealer coatings described herein.

In yet another embodiment, the hydrophobic coating may be formulated as a 100% solids radiation curable composition including at least one film-forming resin or oligomer. Suitable examples include, but are not limited to, mono or polyesters of (meth)acrylic acid such as epoxy, polyester, polyether, and polyurethane(meth)acrylates. In some embodiments, the (meth)acrylate film-forming resins may include epoxy-functional (meth)acrylate resins, which in some embodiments may be multifunctional.

For example, suitable commercially available epoxy(meth)acrylate resins can be obtained from Soltech, Ltd., Yangsan, Kyoungnam, Korea, including, but not limited to bisphenol A epoxy diacrylates available under the trade designations SE 1500, SE 1700, SE 1701, SE 1702, and SE 1703. In various embodiments, the radiation curable 100% solids coating compositions contain, from 5 wt % to 50 wt %, or 10 wt % to 30 wt %, or 15 wt % to 25 wt % of the film-forming resin or oligomer, based on total weight of solids of the formula.

The radiation curable 100% solids coating composition can include one or more different ethylenically unsaturated compounds, preferably one or more (meth)acrylate monomers, which can be used alone as a film-forming resin, or may be used in addition to the epoxy functional (meth)acrylate resins described above. In some embodiments, the (meth)acrylate monomers have two or more (meth)acrylate groups (i.e., they are multifunctional). In an embodiment, the (meth)acryl functional groups of the (meth)acrylate monomers are bonded to core structural groups, which may be based on a wide variety of organic structures including tripropylene glycol, isobornyl alcohol, isodecyl alcohol, phenoxyethyl alcohol, trishydroxyethyl isocyanurate, trimethylolpropane ethoxylate, hexanediol, ethoxylated and propoxylated neopentyl glycol, oxyethylated phenol, polyethylene glycol, bisphenol ethoxylate, neopentyl glycol propoxylate, trimethylolpropane, propoxylated glycerol, di-trimethylolpropane, di and mono pentaerythritol, tetrahydrofurfuryl alcohol, beta-carboxyethyl alcohol, substituted derivatives of the above, combinations of the above, and the like.

Examples of suitable (meth)acrylate monomers include isobornyl(meth)acrylate, isodecyl(meth)acrylate, phenoxyethyl(meth)acrylate, trimethylolpropane tri(meth)acrylate, trimethylolpropane ethoxylate tri(meth)acrylate, tripropylene glycol di(meth)acrylate (TPGDA/TPGDMA), hexanediol di(meth)acrylate (HDDA/HDDMA), tetrahydrofurfuryl(meth)acrylate, beta-carboxyethyl(meth)acrylate, bisphenol A ethoxylate di(meth)acrylate, ethoxylated and propoxylated neopentyl glycol di(meth)acrylates, di-(trimethyolpropane tetra(meth)acrylate) (TMPTA/TMPTMA), pentaerythritol tri(meth)acrylate, pentaerythritol tetra(meth)acrylate, or mixtures thereof.

In various embodiments, the radiation curable 100% solids coating compositions contain from 5 wt % to 75 wt %, or 10 wt % to 60 wt %, or 25 wt % to 50 wt % of the (meth)acrylate monomer, based on total weight of solids of the formula.

An optional ethylenically unsaturated resin may be included in the radiation curable 100% solids coating composition. The ethylenically unsaturated resin may be incorporated to facilitate blending of the components of the coating composition, to increase the solids content without increasing the coating viscosity or volatile organic compound (VOC) content, or to enhance (in some cases, synergistically) various coating performance characteristics such as adhesion, hardness, flexibility, hydrophobicity, and chemical resistance. Suitable ethylenically unsaturated resins include polyesters, acrylics, epoxy, polyethers, and a variety of low molecular weight functional resins.

The optional ethylenically unsaturated resin may, for example, represent less than about 20 wt %, between about 1 wt % and about 15 wt %, between about 1 wt % and about 10 wt %, or between about 1 wt % and about 5 wt %, based on the total weight of the radiation curable 100% solids coating composition.

The radiation curable 100% solids coating compositions may include one or more flow control agents. Flow control agents may facilitate coating the composition onto a substrate. Exemplary flow control agents include silicones, fluorocarbons, acrylic resins, and the like, and may represent between about 0.1 wt % and about 3 wt %, between about 0.4 wt % and about 2 wt %, or between about 0.5 wt % and 1 wt % of the formula.

The radiation curable 100% solids coating compositions are curable by radiation, e.g., visible light, UV light, and the like. A wide variety of photoinitiators can be used in the composition, including, but not limited to, alpha-hydroxyketones, phenylglyoxalates, benzyldimethyl ketals, α-aminoketones, mono acyl phosphine oxides (MAPO), bis acyl phosphine oxides (BAPO), phosphine oxides. Specific photoinitators include, but are not limited to, benzophenone, 1-hydroxy-cyclohexylphenyl-ketone (such as those available under the trade designation IRGACURE 184), methylbenzoylformate (such as those available under the trade designation DAROCUR MBF), alpha, alpha-diethoxy-alpha phenylacetophenone, 1-hydroxycyclohexyl benzophenone, phenyl bis(2,4,6-trimethyl benzoyl)phosphine oxide sold under the trade designation IRGACURE 819 and diphenyl(2,4,6-trimethylbenozyl)phosphine oxide. The photoinitiators may be used singly or in combination. Products identified with the IRGACURE and DAROCUR trade designations are available from BASF AG, Florham Park, N.J.

In the radiation curable 100% solids coating compositions, the photoinitiator is present from about 0.2 wt % to about 15 wt % of the formula. The photoinitiator can be from about 0.5 wt % to about 12 wt %, or from about 1 wt % to about 10 wt % of the formula.

In some embodiments, the radiation curable 100% solids coating compositions can include additional hydrophobic additives such as, for example, silicone compounds. Suitable silicones include, but are not limited to silicone acrylates available from Evonik Industries, Darmstadt, DE. The hydrophobic additives are present at about 1 wt % to about 10 wt %, and in some embodiments at about 2 wt % to about 7 wt %, of the formula.

In other embodiments, the radiation curable 100% solids coating composition can include a mineral filler such as, for example, metal oxides, silica oxides, calcium oxides, boron oxides, and the like; ground glass particles and beads; and ceramic particles and beads. While not wishing to be bound by any theory, presently available evidence indicates that, when the coating composition is applied on a surface of a wood substrate, the mineral filler can become lodged in the grain and at least partially seal the surface of the wood substrate.

The filler particles used in the radiation curable 100% solids coating composition have a particle size ranging from about 1 micron to about 500 microns, more preferably about 1 micron to about 25 microns. The additives can be of a homogeneous particle size or several particle sizes in combination. In some embodiments, the mineral filler is a silica aerogel powder. The silica aerogel powder is available from a variety of sources, such as the material available under the trade designation NANOGEL from Cabot Corp., Boston, Mass. The size of the particles in the silica aerogel powder may be different for each particular circumstance or application, but in many cases the particle sizes are about 8 to about 11 microns.

In one embodiment, the filler particles form forms about 0.1 wt % to about 5 wt % by weight of the radiation curable 100% solids coating composition. Sealer coats/primer coats have higher weight percentages of the filler particles than mineral abrasive-filled top coat compositions.

Other optional components for use in the radiation curable 100% solids coating systems herein are described in Koleske et al., Paint and Coatings Industry, April, 2003, pages 12-86. Typical performance enhancing additives that may be employed include surface active agents, pigments, colorants, dyes, surfactants, dispersants, defoamers, thickeners, heat stabilizers, leveling agents, coalescents, biocides, mildewcides, anti-cratering agents, curing indicators, plasticizers, fillers, sedimentation inhibitors, ultraviolet light absorbers, optical brighteners, and the like to modify properties. In various embodiments, the optional components are present in the radiation curable 100% solids coating composition at less than about 5 wt %, or less than about 2 wt %, or less than about 1 wt % of the formula.

The radiation curable 100% solids coating composition can optionally include at least one organic solvent present at less than about 5 wt % of the formula, or less than about 3 wt % of the formula. In other embodiments, the radiation curable 100% solids coating composition can optionally include at least one organic solvent present at less than about 1 wt % of the formula, which is referred to herein as a substantially solvent free coating composition. The solvent may vary widely depending on the intended application, and suitable examples include naphtha, glycol ethers and the like, and mixtures thereof.

The radiation curable 100% solids coating composition may be applied to the backside or edges of a wood board as a stand-alone sealer or primer coating, or may be used as a top coat over the aqueous coatings described herein.

All the coating compositions described above can be applied on a substrate using any suitable procedure such as brush coating, spray coating, roll coating, curtain coating, vacuum coating fan, sock coating and the like. Spraying and roll coating are preferred application methods.

The target surface may be cleaned and prepared for application of the disclosed coating system using methods (e.g., a solvent wipe or sanding) that will be familiar to those skilled in the art. The coating composition may be applied in one or more layers, with each layer preferably being applied in an amount sufficient to provide good wet coat coverage and a continuous crosslinked coating. Sufficient coats preferably are applied at coating weights sufficient to provide an uppermost coating layer which is continuously glossy before and after drying and exhibits no runs (and on porous surfaces, no strikethrough). On porous wood end grain, this preferably can be accomplished using three or fewer coats and more preferably using two coats or even one coat, at recommended wet coating thicknesses of about 1 to 5 mils (about 0.03 mm to about 0.1 mm).

The applied layers should be exposed to sufficient curing conditions to obtain thorough crosslinking or cure. These conditions may be determined empirically based on the particular equipment and substrate employed, and the surrounding atmosphere, throughput rate and ambient or elevated temperature at the application site. For wood coatings, a sanding step and a de-nibbing step may be employed for appearance improvement after any or all layers of the disclosed coating composition have been applied and cured, and the coating composition may be undercoated or overcoated with one or more additional layers of sealer, stain, primer or topcoat.

The present disclosure also provides coatings prepared or preparable from the coating compositions described herein. The present disclosure also provides methods for coating that involve applying a coating composition to a substrate and allowing the coating composition to cure (e.g., by exposing the coating composition to radiation such as ultraviolet light, thermal energy or a combination thereof).

The coating composition can be applied on a substrate prior to, or after, forming the substrate into an article.

Various embodiments of the invention will now be described with reference to the following non-limiting examples.

### EXAMPLES

### Example 1

### Aqueous Coating Composition

| | | Parts in |
|---|---|---|
| Ingredient | Description (or function) | Formula |
| Permax 805 Resin | PVDC emulsion | 97 |
| Dipropylene glycol | co-solvent | 1.0 |
| methyl ether | | |
| Byk 346 | Silicone surfactant | 0.2 |
| Surfynol 104PA | Nonionic surfactant | 0.1 |
| Water | Solvent | 1.7 |

The coating composition of Example 1 was applied directly on kraft paper with a weight of 38-42 pounds per ream. The coatings were applied at a thickness of about 3-4 mils (0.08 to 0.10 mm) and dried.

The coated kraft paper samples were measured using perm cups and had a moisture vapor transmission rate (MVTR) of 8-40 g/m²/day, compared to about 500 g/m²/day for an uncoated control paper. The MVTR was measured with a 7002 WVT Analyzer available from Illinois Instruments, Johnsburg, Ill.

### Example 2

### Radiation Curable Solvent Borne Coating Composition

| | | Parts in |
|---|---|---|
| Ingredient | Description (or function) | Formula |
| Bomar 641 | Polybutadiene urethane | 50 |
| | acrylate oligomer | |
| SR 833 | Tricyclodecane dimethanol | 10 |
| | diacrylate | |
| IBOA | Isobornyl acrylate monomer | 10 |
| Irgacure 184 | Photoinitiator | 2.0 |
| Genocure MBF | Photoinitiator | 2.0 |
| Benzophenone | Photoinitiator | 1.0 |
| TPO | Photonitiator | 1.0 |
| P104 | Amine diacrylate | 2.0 |
| Modaflow 9200 | Polyacrylic flow additive | 1.0 |
| DC7 | Defoamer | 0.1 |
| Toluene | Solvent | 25 |
| Acetone | Solvent | 20 |

The coating composition of Example 2 was applied to kraft paper and analyzed with perm cups using the same procedure as in Example 1. The paper samples had a MVTR of 20 g/m²/day as measured with the Illinois Instruments 7002 WVT Analyzer.

### Example 3

### UV Curable—100% Solids Coating Composition

| | | Parts in |
|---|---|---|
| Ingredient | Description (or function) | Formula |
| IBOA | Isobornyl acrylate | 51 |
| Solmer SE 1500 | Epoxy acrylate | 23.5 |
| B66/TPGDA | Acrylic resin in TPGDA | 4.7 |
| intermediate | monomer | |
| Nanogel OGD201 | Nano Silica | 0.5 |
| VM&P | Naptha solvent | 0.9 |
| Dowanol DPM | Solvent | 0.9 |
| Ektasolve DE | Solvent | 0.9 |
| Glycol ether EB | Solvent | 0.9 |
| Darocur 1173 | Photoinitiator | 5.0 |
| Lucirin TPO | Photoinitiator | 5.0 |
| Dow Corning 11 | Flow additive | 0.5 |
| Tego Rad 2650 | Silicone additive | 6.3 |

The coating compositions of Example 3 were applied to kraft paper and analyzed with perm cups using the same procedure as in Example 1. The paper samples had a MVTR of 48 g/m²/day as measured with the Illinois Instruments 7002 WVT Analyzer.

### Example 4

### UV Curable—100% Solids Coating Composition

| | | Parts in |
|---|---|---|
| Ingredient | Description (or function) | Formula |
| SR833 | Tricyclodecane dimethanol | 100 |
| | diacrylate | |
| CN309 | Hydrophobic acrylate ester | 100 |
| TPO | Photoinitiator | 5 |
| MBF | Photoinitiator | 8 |
| Modaflow 9200 | Flow agent | 1 |
| SR531 | Cyclic trimethylol propane | 10 |
| | formal acrylate | |
| DC 7 | Defoamer | 0.1 |

The coating compositions of Example 4 were applied to kraft paper and analyzed with perm cups using the same procedure as in Example 1. The resulting paper samples had a MVTR of 10 g/m²/day as measured with the Illinois Instruments 7002 WVT Analyzer.

### Example 5

### Wooden Board Cupping Measurements

The coating compositions detailed in Table 1 below were applied to the backside of hickory boards that were about ¾ inches (2 cm) thick, 5 inches (13 cm) wide and 14 inches (36 cm) long. The coatings were applied at a thickness of about 3-4 mils (0.08 to 0.10 mm) and dried. The top side or face of the board were coated with a commercially available UV-cured floor finish.

About 1 gallon of water was added to a 17.5 inch×23.5 inch×6 inch plastic tray with a top flange. The boards were then joined together and clamped in place over the open top of the tray with their undersides suspended over the water. Caulk was applied around the edges of the boards to form a water-tight seal with the tray. The boards were then removed from the tray after 7 days, and the amount of warping and/or cupping was measured with a caliper.

The coatings of the present disclosure were also compared to a wax edge coating, referred to herein as the control, which was commercially available from Valspar, Minneapolis, Minn. The coatings were also compared to a commercially available aqueous coating available from Michelman Corp., Cincinnati, Ohio, under the trade designation VaporCoat 2200R.

The results are shown in Table 1 below. The boards with a backside coated with the coating compositions of the present disclosure had substantially reduced cupping compared to the control coatings and the comparable commercially available coatings.

TABLE 1

| Test Number | Board Number | Coating Applied | Cupping (mm) |
|---|---|---|---|
| Test 1 | 1 | None | 1.92 |
| | 2 | None | 1.98 |
| | 3 | None | 1.97 |
| | 4 | None | 1.76 |
| Test 2 | 1 | None | 2.14 |
| | 2 | None | 1.49 |
| | 3 | None | 1.88 |
| | 4 | None | 2.15 |
| | 5 | None | 2.06 |
| Test 3 | 1 | None | 1.60 |
| | 2 | None | 1.76 |
| | 3 | None | 1.48 |
| | 4 | None | 2.48 |
| | 5 | None | 2.16 |
| | 6 | Control | 0.91 |
| | 7 | Control | 0.65 |
| | 8 | None | 2.31 |
| Test 4 | 1 | None | 2.20 |
| | 2 | Control | 0.79 |
| | 3 | Control | 0.84 |
| | 4 | Control | 0.43 |
| Test 5 | 1 | Control | 0.69 |
| | 2 | Control | 0.44 |
| | 3 | None | 1.60 |
| | 4 | None | 2.69 |
| | 5 | Example 4 | 0.025 |
| | 6 | Example 4 | 0.03 |
| | 7 | Example 4 | 0.08 |
| | 8 | Example 4 | 0.09 |
| Test 6 | 1 | Control | 0.5 |
| | 2 | Control | 0.44 |
| | 3 | None | 1.68 |
| | 4 | None | 1.71 |
| | 5 | Example 4 topcoat | 0.16 |
| | | Example 1 basecoat | |
| | 6 | Example 4 topcoat | 0.22 |
| | | Example 1 basecoat | |
| | 7 | Example 4 topcoat | 0.46 |
| | | Example 1 basecoat | |
| | 8 | Example 4 topcoat | 0.63 |
| | | Example 1 basecoat | |
| Test 7 | 1 | Control | 0.95 |
| | 2 | Control | 0.73 |
| | 3 | None | 2.34 |
| | 4 | None | 2.87 |
| | 5 | Example 4 | 0.33 |
| | 6 | Example 4 | 0.21 |
| | 7 | Example 4 | 0.48 |
| | 8 | Example 4 | 0.48 |
| Test 8 | 1 | None | 1.76 |
| | 2 | None | 2.41 |
| | 3 | Example 1 basecoat | 0.35 |
| | | Example 4 topcoat | |
| | 4 | Example 1 basecoat | 0.09 |
| | | Example 4 topcoat | |
| | 5 | Example 1 basecoat | 0.11 |
| | | Example 4 topcoat | |
| | 6 | Example 1 basecoat | 0.03 |
| | | Example 4 topcoat | |
| | 7 | Control | 0.39 |
| Test 9 | 1 | None | 1.87 |
| | 2 | None | 2.52 |
| | 3 | Control | 0.74 |
| | 4 | Control | 0.80 |
| | 5 | Example 1 | 0.81 |
| | 6 | Example 1 | 0.47 |
| | 7 | Example 1 | 0.96 |
| | 8 | Example 1 | 0.37 |
| Test 10 | 1 | Control | 0.99 |
| | 2 | Control | 0.43 |
| | 3 | None | 1.61 |
| | 4 | None | 3.28 |
| | 5 | Michelman 2200R | 0.64 |
| | 6 | Michelman 2200R | 0.34 |
| | 7 | Michelman 2200R | 0.56 |
| | 8 | Michelman 2200R | 0.35 |

Various embodiments of the invention have been described. These and other embodiments are within the scope of the following claims.

1. A method comprising applying an aqueous coating composition to a backside of a wooden substrate, wherein the aqueous coating composition comprises a polyvinylidene chloride copolymer and water.

2. The method of claim 1, wherein the aqueous coating composition further comprises at least one surfactant selected from silicone surfactants, nonionic surfactants, and combinations thereof.

3. (canceled)

4. The method of claim 1, wherein the aqueous coating composition comprises at least one organic co-solvent.

5. (canceled)

6. The method of claim 1, further comprising drying the aqueous coating composition.

7. The method of claim 1, further comprising applying a top coat composition over the aqueous coating composition.

8. The method of claim 7, wherein the top coat composition is curable with visible or ultraviolet light.

9. The method of claim 8, wherein the aqueous coating composition is at least partially cured prior to applying the top coat composition.

10. (canceled)

11. The method of claim 7, wherein the top coat composition comprises an epoxy or a polyurethane(meth)acrylate.

12. The method of claim 11, wherein the top coat composition comprises an epoxy or a polyurethane acrylate.

13. A wood board comprising a topside and a backside opposite the topside, wherein the backside comprises a cured aqueous coating composition of claim 1.

14. A method comprising applying an aqueous coating composition to a backside of a wooden board, wherein the aqueous coating composition comprises 70 wt % to 98 wt % of a polyvinylidene chloride resin, about 2 wt % to about 30 wt % water, and than about 1 wt % of at least one surfactant.

15. (canceled)

16. The method of claim 14, further comprising applying a UV curable top coat composition over the aqueous coating composition, wherein the UV curable top coat comprises a urethane or an epoxy(meth)acrylate.

17. The method of claim 16, wherein the top coat composition comprises a urethane acrylate.

18-26. (canceled)

27. A method comprising applying to a backside of a wood board an ultraviolet (UV) curable coating composition comprising about 10 wt % to about 70 wt % of an urethane(meth)acrylate, about 1 wt % to about 50 wt % of a difunctional (meth)acrylate, about 0.1 wt % to 15wt % of at least one photoinitiator, and about 3 wt % to about 50 wt % of at least one organic solvent, and curing the coating composition.

28-29. (canceled)

30. The method of claim 27, further comprising applying a primer coating composition to a surface of the backside of the wood board prior to applying the UV curable coating composition, wherein the primer coating composition comprises a polyvinylidene chloride copolymer and water.

31. (canceled)

32. The method of claim 30, further comprising drying the primer coating composition prior to applying the UV curable coating composition.

33. The method of claim 27, wherein UV curable coating composition further comprises about 1 wt % to about 20 wt % of at least one acrylic resin.

34. (canceled)

35. A method of coating a substrate, the method comprising applying the UV curable coating composition of claim 27 to a backside of a wooden board and curing the coating composition, wherein the wooden board is hardwood with a width of at least 10 cm.

36-38. (canceled)

39. The method of claim 27, wherein the coating composition further comprises a mineral filler.

40. The method of claim 39, wherein the mineral filler comprises silica.

41-58. (canceled)
